(19) United States
(12) Patent Application Publication
(10) Pub. No.: US 2024/0211806 A1
(43) Pub. Date: Jun. 27, 2024

(54) SENSOR DATA FRAMEWORK

(71) Applicant: Schlumberger Technology Corporation, Sugar Land, TX (US)

(72) Inventors: Thanh Nhan Nguyen, Clamart (FR); Aymeric Lilian Jan, Clamart (FR); Makan Shapouri, Clamart (FR)

(21) Appl. No.: 18/389,862

(22) Filed: Dec. 20, 2023

Related U.S. Application Data
(60) Provisional application No. 63/476,648, filed on Dec. 22, 2022.

(51) Int. Cl. G06N 20/00

(52) U.S. Cl. CPC G06N 20/00

(57) ABSTRACT

A method can include receiving a first set of time series sensor data of a region and a second set of time series sensor data of the region; training a regression model using the first set and the second set to generate a trained regression model; transforming at least a portion of the first set to a comparison space, using the trained regression model, to generate a comparison set; and comparing at least a portion of the second set to the comparison set to determine variation between the first set and the second set with respect to the region.

### CROSS-REFERENCE TO RELATED APPLICATION

This application claims priority to U.S. Provisional Patent Application No. 63/476,648, filed on Dec. 22, 2022, which is incorporated by reference herein.

### BACKGROUND

Various types of equipment can acquire time series data. For example, consider a drillstring tool, a wireline tool, or a coiled tubing tool that can be moved in a borehole where a sensor can acquire data with respect to time. In such an example, the sensor may acquire data with respect to time over a range of measured depths in a borehole where, for example, data can be acquired over a first period of time while moving the sensor in hole and can be acquired over a second period of time while moving the sensor out of hole. In such an example, the data for a common span of the borehole may be expected to be quite similar, under an assumption that one or more physical phenomena do not change appreciable between the first period of time and second period of time.

In the context of a borehole, it may be a borehole that extends to a reservoir, which can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may be developed within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations. In such an example, control may be based at least in part on characteristics of rock where drilling into such rock forms a borehole that can be completed to form a well to produce from a reservoir and/or to inject fluid into a reservoir. While hydrocarbon fluid reservoirs are mentioned as an example, a reservoir that includes water or brine may be assessed, for example, for one or more purposes such as, for example, carbon storage (e.g., sequestration), water production or storage, geothermal production or storage, metallic extraction from brine, etc.

As explained, various types of equipment can acquire time series data where such data may be utilized for one or more purposes. An ability to assess such data, particularly with respect to repeatability and/or reliability, can improve one or more of data acquisition processes, sensor design, sensor maintenance, sensor-based control, sensor-based workflows, etc.

### SUMMARY

A method can include receiving a first set of time series sensor data of a region and a second set of time series sensor data of the region; training a regression model using the first set and the second set to generate a trained regression model; transforming at least a portion of the first set to a comparison space, using the trained regression model, to generate a comparison set; and comparing at least a portion of the second set to the comparison set to determine variation between the first set and the second set with respect to the region. A system can include one or more processors; memory accessible to at least one of the one or more processors; processor-executable instructions stored in the memory and executable to instruct the system to: receive a first set of time series sensor data of a region and a second set of time series sensor data of the region; train a regression model using the first set and the second set to generate a trained regression model; transform at least a portion of the first set to a comparison space, using the trained regression model, to generate a comparison set; and compare at least a portion of the second set to the comparison set to determine variation between the first set and the second set with respect to the region. One or more computer-readable storage media can include processor-executable instructions to instruct a computing system to: receive a first set of time series sensor data of a region and a second set of time series sensor data of the region; train a regression model using the first set and the second set to generate a trained regression model; transform at least a portion of the first set to a comparison space, using the trained regression model, to generate a comparison set; and compare at least a portion of the second set to the comparison set to determine variation between the first set and the second set with respect to the region. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates an example of a system;

FIG. 3 illustrates an example of a drilling equipment and examples of borehole shapes;

FIG. 4 illustrates an example of a system;

FIG. 5 illustrates an example of a method;

FIG. 6 illustrates an example of a method;

FIG. 7 illustrates examples of plots;

FIG. 8 illustrates an example of a method and an example of a system; and

FIG. 9 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

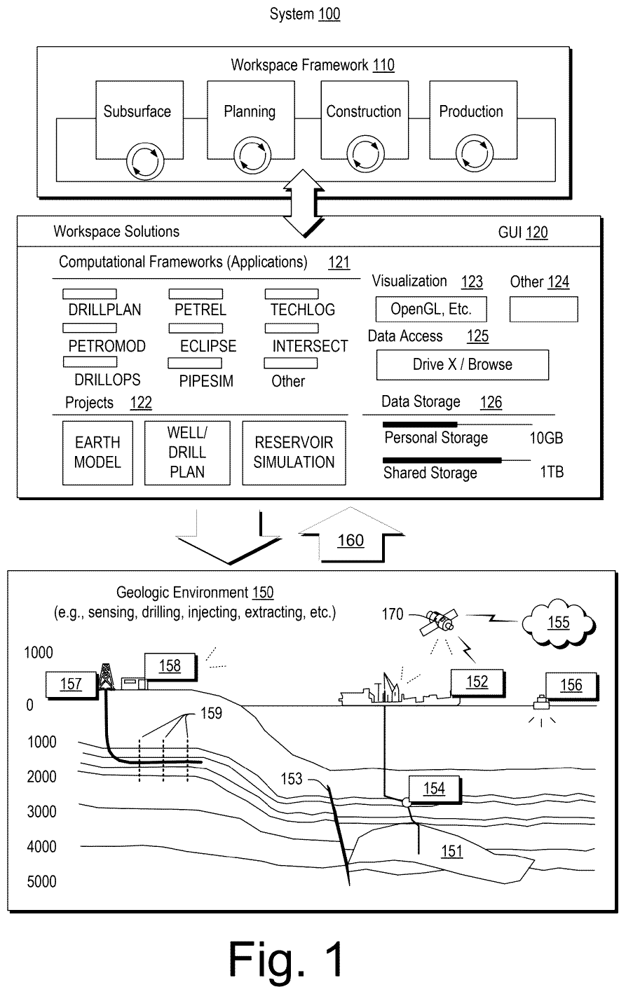

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in rock and fluid properties, formation stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, DRILLOPS, PETREL, TECHLOG, PETROMOD, ECLIPSE, PIPESIM, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework can execute a digital drilling plan and ensures plan adherence, while delivering goal-based automation. The DRILLOPS framework can generate activity plans automatically individual operations, whether they are monitored and/or controlled on the rig or in town. Automation can utilize data analysis and learning systems to assist and optimize tasks, such as, for example, setting ROP to drilling a stand. A preset menu of automatable drilling tasks can be rendered, and, using data analysis and models, a plan can be executed in a manner to achieve a specified goal, where, for example, measurements can be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) can be continually monitored and dynamically updated using feedback from operational activities. The DRILLOPS framework can provide for various levels of automation based on planning and/or re-planning (e.g., via the DRILLPLAN framework), feedback, etc.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The PIPESIM simulator includes solvers that may provide simulation results such as, for example, multiphase flow results (e.g., from a reservoir to a wellhead and beyond, etc.), flowline and surface facility performance, etc. The

PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data.

A simulator can be a computerized system (e.g., a computing system) that can execute instructions using one or more processors to solve a system of equations that describe physical phenomena subject to various constraints. While several simulators are illustrated in the example of FIG. 1, one or more other simulators may be utilized, additionally or alternatively.

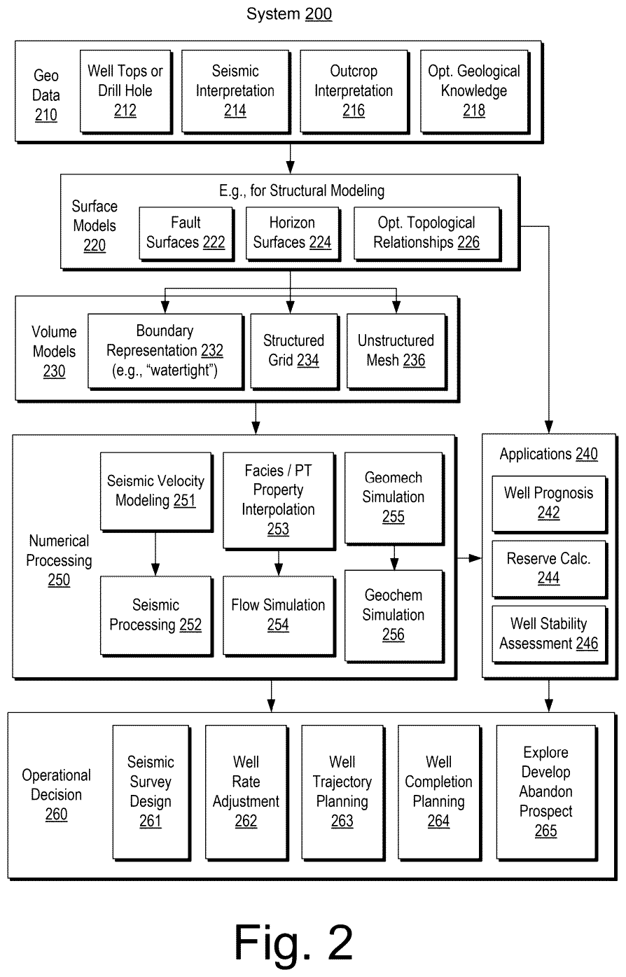

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due to underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, DRILLOPS, PETREL, TECHLOG, PETROMOD, PIPESIM, ECLIPSE, INTERSECT, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

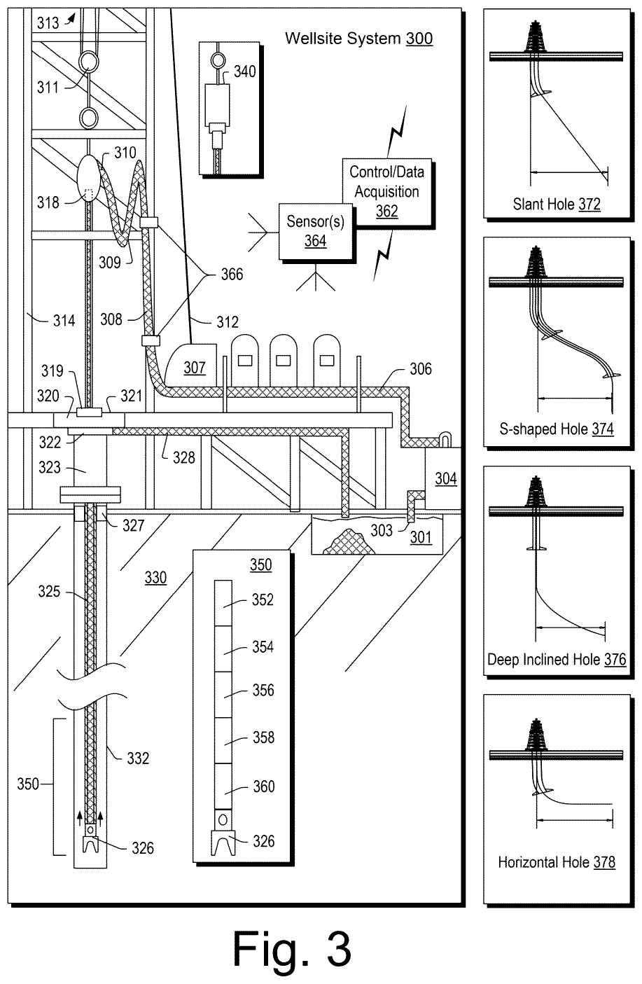

FIG. 3 shows an example of a wellsite system 300 (e.g., at a wellsite that may be onshore or offshore). As shown, the wellsite system 300 can include a mud tank 301 for holding mud and other material (e.g., where mud can be a drilling fluid), a suction line 303 that serves as an inlet to a mud pump 304 for pumping mud from the mud tank 301 such that mud flows to a vibrating hose 306, a drawworks 307 for winching drill line or drill lines 312, a standpipe 308 that receives mud from the vibrating hose 306, a kelly hose 309 that receives mud from the standpipe 308, a gooseneck or goosenecks 310, a traveling block 311, a crown block 313 for carrying the traveling block 311 via the drill line or drill lines 312, a derrick 314, a kelly 318 or a top drive 340, a kelly drive bushing 319, a rotary table 320, a drill floor 321, a bell nipple 322, one or more blowout preventors (BOPs) 323, a drillstring 325, a drill bit 326, a casing head 327 and a flow pipe 328 that carries mud and other material to, for example, the mud tank 301.

In the example system of FIG. 3, a borehole 332 is formed in subsurface formations 330 by rotary drilling; noting that various example embodiments may also use one or more directional drilling techniques, equipment, etc.

As shown in the example of FIG. 3, the drillstring 325 is suspended within the borehole 332 and has a drillstring assembly 350 that includes the drill bit 326 at its lower end. As an example, the drillstring assembly 350 may be a bottom hole assembly (BHA).

The wellsite system 300 can provide for operation of the drillstring 325 and other operations. As shown, the wellsite system 300 includes the traveling block 311 and the derrick 314 positioned over the borehole 332. As mentioned, the wellsite system 300 can include the rotary table 320 where the drillstring 325 pass through an opening in the rotary table 320.

As shown in the example of FIG. 3, the wellsite system 300 can include the kelly 318 and associated components, etc., or the top drive 340 and associated components. As to a kelly example, the kelly 318 may be a square or hexagonal metal/alloy bar with a hole drilled therein that serves as a mud flow path. The kelly 318 can be used to transmit rotary motion from the rotary table 320 via the kelly drive bushing 319 to the drillstring 325, while allowing the drillstring 325 to be lowered or raised during rotation. The kelly 318 can pass through the kelly drive bushing 319, which can be driven by the rotary table 320. As an example, the rotary table 320 can include a master bushing that operatively couples to the kelly drive bushing 319 such that rotation of the rotary table 320 can turn the kelly drive bushing 319 and hence the kelly 318. The kelly drive bushing 319 can include an inside profile matching an outside profile (e.g., square, hexagonal, etc.) of the kelly 318; however, with slightly larger dimensions so that the kelly 318 can freely move up and down inside the kelly drive bushing 319.

As to a top drive example, the top drive 340 can provide functions performed by a kelly and a rotary table. The top drive 340 can turn the drillstring 325. As an example, the top drive 340 can include one or more motors (e.g., electric and/or hydraulic) connected with appropriate gearing to a short section of pipe called a quill, that in turn may be screwed into a saver sub or the drillstring 325 itself. The top drive 340 can be suspended from the traveling block 311, so the rotary mechanism is free to travel up and down the derrick 314. As an example, a top drive 340 may allow for drilling to be performed with more joint stands than a kelly/rotary table approach.

In the example of FIG. 3, the mud tank 301 can hold mud, which can be one or more types of drilling fluids. As an example, a wellbore may be drilled to produce fluid, inject fluid or both (e.g., hydrocarbons, minerals, water, etc.).

In the example of FIG. 3, the drillstring 325 (e.g., including one or more downhole tools) may be composed of a series of pipes threadably connected together to form a long tube with the drill bit 326 at the lower end thereof. As the drillstring 325 is advanced into a wellbore for drilling, at some point in time prior to or coincident with drilling, the mud may be pumped by the pump 304 from the mud tank 301 (e.g., or other source) via the lines 306, 308 and 309 to a port of the kelly 318 or, for example, to a port of the top drive 340. The mud can then flow via a passage (e.g., or passages) in the drillstring 325 and out of ports located on the drill bit 326 (see, e.g., a directional arrow). As the mud exits the drillstring 325 via ports in the drill bit 326, it can then circulate upwardly through an annular region between an outer surface(s) of the drillstring 325 and surrounding wall(s) (e.g., open borehole, casing, etc.), as indicated by directional arrows. In such a manner, the mud lubricates the drill bit 326 and carries heat energy (e.g., frictional or other energy) and formation cuttings to the surface where the mud may be returned to the mud tank 301, for example, for recirculation with processing to remove cuttings and other material.

In the example of FIG. 3, processed mud pumped by the pump 304 into the drillstring 325 may, after exiting the drillstring 325, form a mudcake that lines the wellbore which, among other functions, may reduce friction between the drillstring 325 and surrounding wall(s) (e.g., borehole, casing, etc.). A reduction in friction may facilitate advancing or retracting the drillstring 325. During a drilling operation, the entire drillstring 325 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 326 of the drillstring 325 at a bottom of a wellbore, pumping of the mud commences to lubricate the drill bit 326 for purposes of drilling to enlarge the wellbore. As mentioned, the mud can be pumped by the pump 304 into a passage of the drillstring 325 and, upon filling of the passage, the mud may be used as a transmission medium to transmit energy, for example, energy that may encode information as in mud-pulse telemetry. Characteristics of the mud can be utilized to determine how pulses are transmitted (e.g., pulse shape, energy loss, transmission time, etc.).

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 325) may be transmitted uphole to an uphole device, which may relay such information to other equipment for processing, control, etc.

As an example, telemetry equipment may operate via transmission of energy via the drillstring 325 itself. For example, consider a signal generator that imparts coded energy signals to the drillstring 325 and repeaters that may receive such energy and repeat it to further transmit the coded energy signals (e.g., information, etc.).

As an example, the drillstring 325 may be fitted with telemetry equipment 352 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 3, an uphole control and/or data acquisition system 362 may include circuitry to sense pressure pulses generated by telemetry equipment 352 and, for example, communicate sensed pressure pulses or information derived therefrom for process, control, etc.

The assembly 350 of the illustrated example includes a logging-while-drilling (LWD) module 354, a measurement-while-drilling (MWD) module 356, an optional module 358, a rotary-steerable system (RSS) and/or motor 360 (e.g., a mud motor), and the drill bit 326. Such components or modules may be referred to as tools where a drillstring can include a plurality of tools.

In the example of FIG. 3, the LWD module 354 may be housed in a suitable type of drill collar and can contain one or a plurality of selected types of logging tools. It will also be understood that more than one LWD and/or MWD module can be employed, for example, as represented at by the module 356 of the drillstring assembly 350. Where the position of an LWD module is mentioned, as an example, it may refer to a module at the position of the LWD module 354, the module 356, etc. An LWD module can include capabilities for measuring, processing, and storing information, as well as for communicating with the surface equipment. In the illustrated example, the LWD module 354 may include a seismic measuring device.

The MWD module 356 may be housed in a suitable type of drill collar and can contain one or more devices for measuring characteristics of the drillstring 325 and the drill bit 326. As an example, the MWD tool 354 may include equipment for generating electrical power, for example, to power various components of the drillstring 325. As an example, the MWD tool 354 may include the telemetry equipment 352, for example, where the turbine impeller can generate power by flow of the mud; it being understood that other power and/or battery systems may be employed for purposes of powering various components. As an example, the MWD module 356 may include one or more of the following types of measuring devices: a weight-on-bit measuring device, a torque measuring device, a vibration measuring device, a shock measuring device, a stick slip measuring device, a direction measuring device, and an inclination measuring device.

FIG. 3 also shows some examples of types of holes that may be drilled. For example, consider a slant hole 372, an S-shaped hole 374, a deep inclined hole 376 and a horizontal hole 378. A directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, a system may be a steerable system and may include equipment to perform a method such as geosteering. A steerable system can include equipment on a lower part of a drillstring which, just above a drill bit, a bent sub may be mounted. Above directional drilling equipment, a drillstring can include MWD equipment that provides real time or near real time data of interest (e.g., inclination, direction, pressure, temperature, real weight on the drill bit, torque stress, etc.) and/or LWD equipment. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment to follow a desired route to reach a desired target or targets.

A drillstring may include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

Geosteering can include intentional directional control of a wellbore based on results of downhole geological logging measurements in a manner that aims to keep a directional wellbore within a desired region, zone (e.g., a pay zone), etc. Geosteering may include directing a wellbore to keep the wellbore in a particular section of a reservoir, for example, to minimize gas and/or water breakthrough and, for example, to maximize economic production from a well that includes the wellbore.

Referring again to FIG. 3, the wellsite system 300 can include one or more sensors 364 that are operatively coupled to the control and/or data acquisition system 362. As an example, a sensor or sensors may be at surface locations. As an example, a sensor or sensors may be at downhole locations. As an example, a sensor or sensors may be at one or more remote locations that are not within a distance of the order of approximately one hundred meters from the wellsite system 300.

The system 300 can include one or more sensors 366 that can sense and/or transmit signals to a fluid conduit such as a drilling fluid conduit (e.g., a drilling mud conduit). For example, in the system 300, the one or more sensors 366 can be operatively coupled to portions of the standpipe 308 through which mud flows. As an example, a downhole tool can generate pulses that can travel through the mud and be sensed by one or more of the one or more sensors 366. In such an example, the downhole tool can include associated circuitry such as, for example, encoding circuitry that can encode signals, for example, to reduce demands as to transmission. Circuitry at the surface may include decoding circuitry to decode encoded information transmitted at least in part via mud-pulse telemetry. Circuitry at the surface may include encoder circuitry and/or decoder circuitry and circuitry downhole may include encoder circuitry and/or decoder circuitry. As an example, the system 300 can include a transmitter that can generate signals that can be transmitted downhole via mud (e.g., drilling fluid) as a transmission medium.

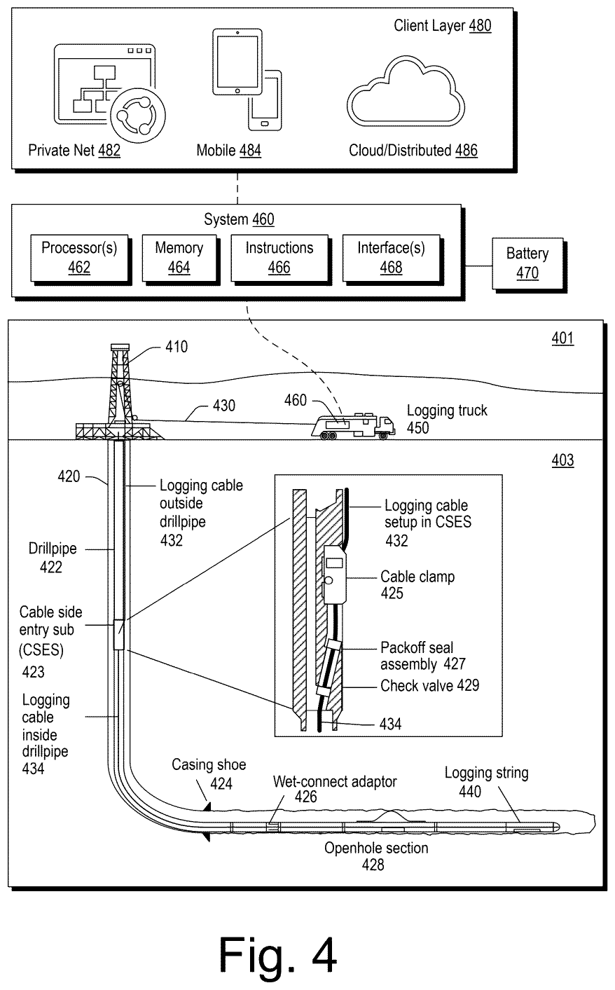

FIG. 4 shows an example of an environment 401 that includes a subterranean portion 403 where a rig 410 is positioned at a surface location above a bore 420. In the example of FIG. 4, various wirelines services equipment can be operated to perform one or more wirelines services including, for example, acquisition of data from one or more positions within the bore 420.

As an example, a wireline tool and/or a wireline service may provide for acquisition of data, analysis of data, data-based determinations, data-based decision making, etc. Some examples of wireline data can include gamma ray (GR), spontaneous potential (SP), caliper (CALI), shallow resistivity (LLS), deep resistivity (LLD and ILD), density (RHOB), neutron porosity (BPHI or TNPH or NPHI), sonic (DT), photoelectric (PEF), permittivity and conductivity.

In the example of FIG. 4, the bore 420 includes drillpipe 422, a casing shoe 424, a cable side entry sub (CSES) 423, a wet-connector adaptor 426 and an openhole section 428. As an example, the bore 420 can be a vertical bore or a deviated bore where one or more portions of the bore may be vertical and one or more portions of the bore may be deviated, including substantially horizontal.

In the example of FIG. 4, the CSES 423 includes a cable clamp 425, a packoff seal assembly 427 and a check valve 429. These components can provide for insertion of a logging cable 430 that includes a portion 432 that runs outside the drillpipe 422 to be inserted into the drillpipe 422 such that at least a portion 434 of the logging cable runs inside the drillpipe 422. In the example of FIG. 4, the logging cable 430 runs past the casing shoe 424 and the wet-connect adaptor 426 and into the openhole section 428 to a logging string 440.

As shown in the example of FIG. 4, a logging truck 450 (e.g., a wirelines services vehicle) can deploy the wireline 430 under control of a system 460. As shown in the example of FIG. 4, the system 460 can include one or more processors 462, memory 464 operatively coupled to at least one of the one or more processors 462, instructions 466 that can be, for example, stored in the memory 464, and one or more interfaces 468. As an example, the system 460 can include one or more processor-readable media that include processor-executable instructions executable by at least one of the one or more processors 462 to cause the system 460 to control one or more aspects of equipment of the logging string 440 and/or the logging truck 450. In such an example, the memory 464 can be or include the one or more processor-readable media where the processor-executable instructions can be or include instructions. As an example, a processor-readable medium can be a computer-readable storage medium that is not a signal and that is not a carrier wave.

FIG. 4 also shows a battery 470 that may be operatively coupled to the system 460, for example, to power the system 460. As an example, the battery 470 may be a back-up battery that operates when another power supply is unavailable for powering the system 460 (e.g., via a generator of the wirelines truck 450, a separate generator, a power line, etc.). As an example, the battery 470 may be operatively coupled to a network, which may be a cloud network. As an example, the battery 470 can include smart battery circuitry and may be operatively coupled to one or more pieces of equipment via a SMBus or other type of bus.

As an example, the system 460 can be operatively coupled to a client layer 480. In the example of FIG. 4, the client layer 480 can include features that allow for access and interactions via one or more private networks 482, one or more mobile platforms and/or mobile networks 484 and via the “cloud” 486, which may be considered to include distributed equipment that forms a network such as a network of networks. As an example, the system 460 can include circuitry to establish a plurality of connections (e.g., sessions). As an example, connections may be via one or more types of networks. As an example, connections may be client-server types of connections where the system 460 operates as a server in a client-server architecture. For example, clients may log-in to the system 460 where multiple clients may be handled, optionally simultaneously.

While the example of FIG. 4 shows the system 460 as being associated with the logging truck 450, one or more features of the system 460 may be included in a downhole assembly, which may be a wireline assembly and/or a LWD assembly. In such an approach, various computations may be performed downhole where results thereof may be optionally transmitted to surface (e.g., to the logging truck 450, etc.) using one or more telemetric technologies and/or techniques (e.g., mud-pulse telemetry, wireline, etc.).

Various types of equipment can acquire time series data. For example, consider a drillstring tool, a wireline tool, or a coiled tubing tool that can be moved in a borehole where a sensor can acquire data with respect to time. In such an example, the sensor may acquire data with respect to time over a range of measured depths in a borehole where, for example, data can be acquired over a first period of time while moving the sensor in hole and can be acquired over a second period of time while moving the sensor out of hole. In such an example, the data for a common span of the borehole may be expected to be quite similar, under an assumption that one or more physical phenomena do not change appreciable between the first period of time and second period of time. For example, consider a tool that includes a sensor that can acquire sensor data indicative of formation properties to discern lithology of a stratified geologic environment. In such an example, the run in-hole (RIH) data and the pull out-of-hole (POOH) data may be expected to be quite similar given that no appreciable changes occur in the formation properties.

As another example, consider a tool that includes multiple sensors that may be at different positions on the tool. For example, consider a scanning tool that can implement a pulse-echo (normal-incidence) technique with transducers, specifically, a transreceiver and a flexural wave imager that includes a transmitter and two receivers (e.g., consider the ISOLATION SCANNER TOOL, SLB, Houston, Texas). In such an example, the scanning tool can excite a casing flexural mode in a cased borehole where acquired data can be processed to determine characteristics of material immediately behind the casing (e.g., cement) and to identify corrosion or drilling-induced wear through measurement of the inside diameter and thickness of the casing. In particular, flexural wave measurements can provide third-interface echoes (TIEs) between an annulus and a borehole or outer casing. A TIEs image can provide for borehole shape and define the position of the casing within the borehole or outer casing, and image the outer string to reveal corrosion and damage. Such data in the context of a cased hole environment can help in assessing casing and cementing techniques, choosing cut points on casing retrieval jobs, and providing context for other evaluation services run through casing. For such a multiple sensor tool, each of the multiple sensors of a common sensor type may be expected to acquire quite similar data, as time series or as depth series, whether the data are RIH data and/or POOH data.

In various scenarios, sensor repeatability and reproducibility (R&R) may be of interest. As to R&R analysis, variation on measurement results that originate from an instrument used for the measurement can be expected to be substantially smaller than variations originated from a measured object or objects. Repeatability can be defined as the variation of repeated measurement results taken from the same instrument, operator, part and time. Reproducibility can be defined as the variation of repeated measurement results from one or more of a different instrument or a different operator or a different time. R&R analysis may aim to quantify the variation on measurement results that comes from an instrument in use, to isolate sources that cause variations on the measurement results of the instrument, and to determine whether an instrument (e.g., including the operator and the procedure) is capable to perform a measurement task.

As an example, a method can include applying an R&R analysis to one or more types of time series and/or depth series data. As an example, a framework can include features for performing such a method, which may be, for example, a transformation method for purposes of agreement analysis and inconsistency detection on series data (e.g., interval and/or continuous measurements). Results of an agreement analysis and/or inconsistency detection can be utilized, for example, for purposes of control of one or more field operations, building one or more models, planning one or more field operations, designing surface and/or subsurface systems, etc. For example, consider use of such results in the system 100 of FIG. 1, the system 200 of FIG. 2, the system 300 of FIG. 3 and/or the system 400 of FIG. 4.

As explained, to increase reliability of measurements, a single sensor or sensor package may be utilized to perform a measurement at a location several times or, for example, multiple sensors may be utilized to capture a common quantity. Depending on various conditions (e.g., measurements conditions), there may be a desire to perform a repeatability analysis and/or a reproducibility analysis.

In a discrete measuring process (e.g., using a caliper to measure the inner/outer diameter of a pipe), an R&R analysis can be readily performed by a statistical process such as analysis of variance (ANOVA). However, controlling measuring condition can be impractical in various scenarios. For example, in well logging measurement, well condition can change during a different pass/run of a measuring tool and observers may also differ. Agreement (e.g., repeatability and/or reproducibility) analysis in such scenarios can be exceedingly difficult to perform. Furthermore, there can be scenarios where a measurement is coming from different sensors, which may indicate a different behavior for a short period; whereas, they may otherwise agree the rest of the time.

As an example, a framework can provide for automatically detecting regions where responses of different sensors and/or of different runs, passes, measurements, etc., are not the same. As an example, such a framework may implement one or more approaches. For example, consider a time series transformation approach for converting measuring data into a common condition that allows for agreement analysis to be performed in a manner akin to a repeatability analysis; and consider time series inconsistent repeatability and/or reproducibility detection. Such a framework may be suitably applied to a wide range of sensor monitoring problems in scenarios involving an Internet of Things (IoT) architecture, in the oil and gas industry, in medical applications, etc.

As explained, a scenario can involve using multiple sensors or running several passes to measure on a common well interval, which may be performed in an effort to increase measurement reliability. As mentioned, a tool can include multiple receivers such as, for example, two ultrasonic receivers, which may be located in near and far positions with respect to an emitter. Though there are discrepancy in locations, measuring signals derived from a common source and propagated through a common environment can be expected to follow some certain level of agreement. For example, the average level of amplitudes of the near signals and amplitudes of the far signals can be expected to follow a common trend. However, due to discrepancy in received signals from two distinct locations, analyzing their agreement becomes a more complex task. In cement bond logging (CBL) and variable density logging (VDL), sonic measurement can be utilized for detecting free pipe. In such an example, a client may demand that a service team repeat measurements on a short interval of a well for analyzing repeatability and/or reproducibility. Because of possible variation such as the change in well fluid, in the configurations of tools, of logging speed, etc., there can be various levels of discrepancy in measurement conditions. Such variation can demand considerable effort in adjusting parameters to match measurement results for purposes of performing an agreement analysis.

As explained, a framework can include features for implementation of one or more approaches to agreement analysis, which can include features for implementing a method for transforming time series measurements such that they are optimally matched for agreement analysis and/or for inconsistent repeatability and/or reproducibility detection.

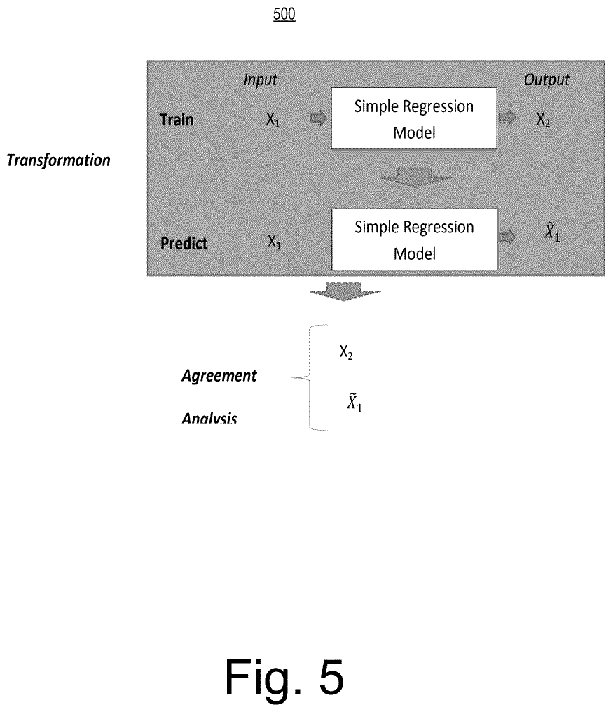

FIG. 5 shows an example of a time series repeatability analysis 500 that includes a transformation process. The time series repeatability analysis 500 may be implemented automatically by a framework, for example, to check the repeatability and reproducibility of time series measurements automatically.

In the example of FIG. 5, the analysis 500 can include a learning step where a regression model (e.g., a linear regression model) is used to learn a transformation of a measured time series to match to a target measured time series. The transformation can then be applied to the measured time series to generate a predicted output for comparison with the target measured time series.

Given that uncontrollable environment factors such as, for example, fluid/environment resistance to sonic/ultrasonic signals, the gains applied in receivers, etc., tend to be mostly linear in their influence, a linear regression model can be utilized to efficiently and effectively model a relationship and hence provide for effective transformers to convert a measurement under one or more different conditions into a common comparable space. Once the transformation is applied, one or more agreement and/or repeatability analyses may be adopted and applied.

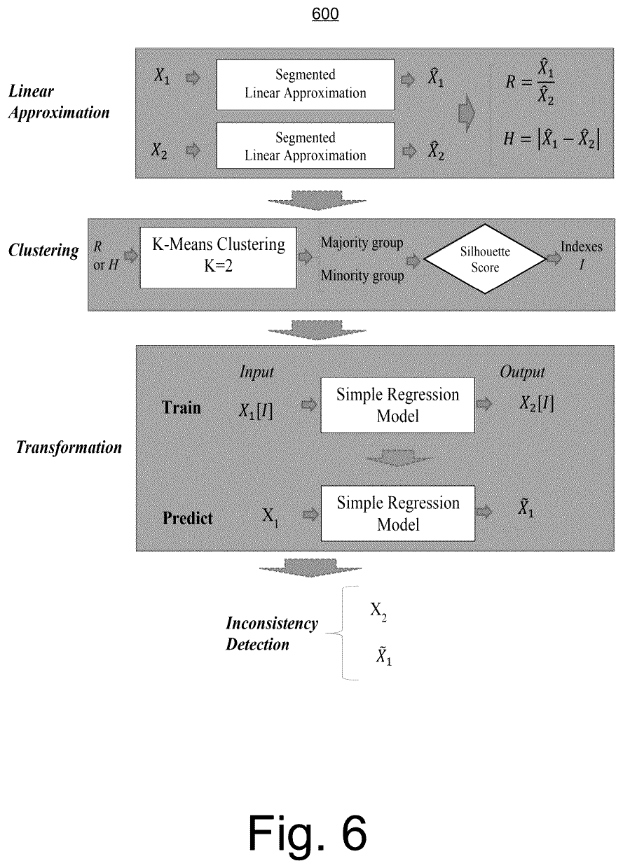

FIG. 6 shows an example of inconsistent repeatability detection process 600. In various scenarios, inconsistency may occur solely in relatively short intervals of time series measurements. For example, in oil and gas industry, as logging a well may be performed for a relatively long depth interval, there can be scenarios where measurement data disagree over some relatively short depth intervals; whereas, a larger portion of the measurement data suitably agree. As an example, a framework may provide for performance of the inconsistent repeatability detection process 600 in a manner that can automatically detect regions where responses of different sensors and/or of different runs/passes/measurements are discrepant. In the example of FIG. 6, the process 600 includes various actions for detecting inconsistency in repeatability of two time series.

As shown in FIG. 6, the process can include a preprocessing action to select a majority of data points, which are suitably coherent between the multiple measurements, before adopting a transformation learning, for example, as explained with respect to the example analysis 500 of FIG. 5. For selecting well-agreed data points, first, an optimal algorithm can be used to create segmented linear approximations for measured time series. Such an approach can help to discard the influence of noise (e.g., enhance signal in the measured time series). Second, a k-mean clustering or other suitable clustering may be performed. For example, consider a k-means approach where k is set equal to 2, noting that k may be generally set to a value greater than 1 and less than approximately 6. In such an example, with k=2, clustering can be utilized to cluster a ratio and/or an absolute subtraction of two approximated outputs. As an example, a process may utilize a silhouette score to assess quality of clustering. In such an example, if the score is high, which means that the data are suitably separated, then the data points of the majority group can be used for transformation learning. Otherwise, the available data points can be used. In such a manner, highly disagreed measured points can be readily detected.

As to a silhouette score (e.g., coefficient), it can be generated in a silhouette analysis that provides for assessment of the separation distance between resulting clusters. For example, a silhouette plot can be generated that displays a measure of how close each point in one cluster is to points in one or more neighboring clusters and thus provide a way to assess parameters such as, for example, number of clusters visually. A silhouette score may be defined within a range such as, for example, a range of [−1, 1]. Silhouette scores near +1 can indicate that a sample is distant from a neighboring cluster; whereas, a value of 0 can indicates that a sample is on or very close to a decision boundary between two neighboring clusters. A negative value can indicate that a sample might have been assigned to the wrong cluster.

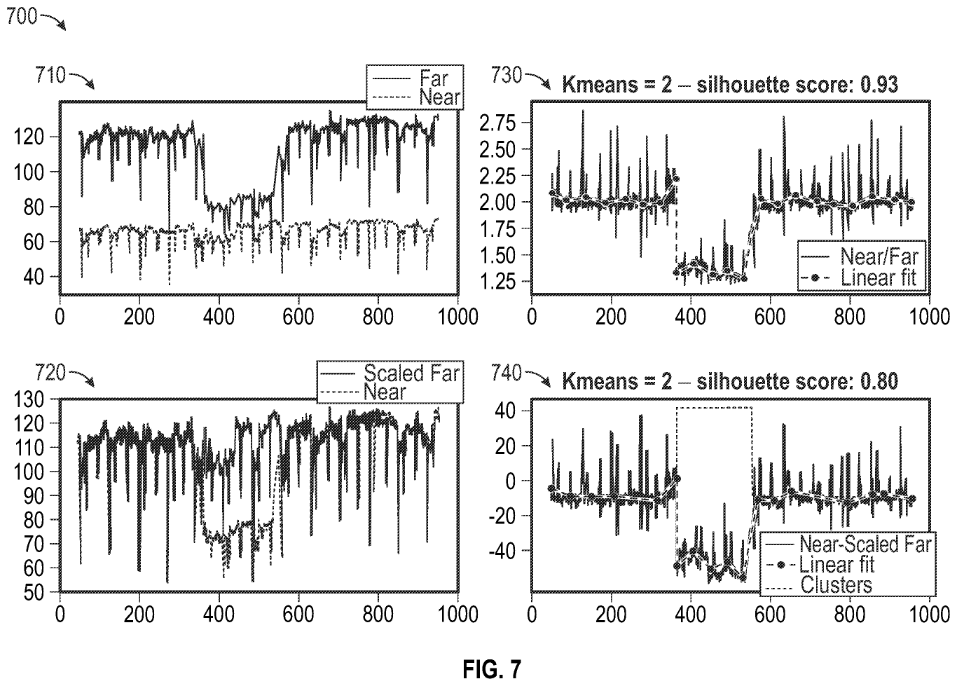

FIG. 7 shows example plots 710, 720, 730, and 740 that correspond to detection for near/far failure in an oil and gas project using an isolation scanner tool. In the example plots 710, 720, 730, and 740, data are for near and far receivers, which are subjected to an agreement analysis. In the upper left plot 710, signal amplitudes at near and far receivers are shown that are in two different ranges and scales. In the upper right plot 730, a linear approximation of the ratio of near and far signal (e.g., a metric) are shown as generated based on a silhouette score of a k-means (k=2) clustering process. In the lower left plot 720, a transformed (scaled) far signal and the original near signal are shown. In the lower right plot 740, a subtraction of the near signal and transformed far signal are shown for the linear approximation and a 2-means cluster with a corresponding silhouette score.

In the plots 710, 720, 730 and 740, the x-axis indicates sample number of the time series data while the y-axis indicates amplitude in the plots 710, 720 and 740 (e.g., raw, scaled and/or transformed) and indicates a metric value in the plot 730 (e.g., a ratio value). The near sensor data are shown in orange (higher amplitude series) in the plot 710 while the far sensor data are shown in blue (lower amplitude series). The data tends to include common indicia of spikes, which are substantially aligned with respect to sample number. As explained, one or both sets of data can be scaled, for example, as shown in the plot 720 (scaled far data to match near data). In the plot 730, the clustering, using a two cluster approach on the selected metric, can generate a cluster that is at approximately a value of 2.0 on the y-axis (e.g., a first ratio value) and another cluster that is at approximately a value of 1.35 on the y-axis (e.g., a second ratio value).

As explained, in some instances the number of clusters may be greater than two. For example, consider a three cluster approach where a first cluster is for times less than approximately 375 on the x-axis and a y-axis value of approximately 2.0, a second cluster is for times between approximately 375 and 590 on the x-axis and a y-axis value of approximately 1.35, and a third cluster is for times between approximately 590 and 1000 on the x-axis and a y-axis value of approximately 2.0. In such an example, the first and third clusters may be considered majority data as they have substantially the same y-axis value. Such an approach may assist with windowing where, for example, a sliding window may be applied. In such an example, a width of a sliding window may be applied to generate sufficient clustering such that portions of the majority of the data form an envelope for the minority of the data that is to be subjected to transformation. As an example, member size of a cluster may be taken into account where a window is sized to provide for suitable clustering (e.g., using k-means or other clustering).

Referring again to the plot 730, the metric, a ratio, for the near and far data is represented in a common space where a linear model can be applied, which may help to effectively reduce the impact of noise. As explained, the plot 730 shows the linear approximation of the ratio of near and far signal (e.g., amplitude) along with a silhouette score of an applied k-means (k=2) clustering. The metric for the near and far data can be suitably selected for purposes of appropriate clustering. As explained, the plot 720 shows the transformed (scaled) far signal and the original near signal and the plot 740 shows a subtraction of the near signal and the transformed far signal, its linear approximation and a 2-means cluster result with a corresponding silhouette score. The 2-means clustering in the plot 740 identifies a cluster that includes members that do not correspond to the majority (e.g., not majority members). Thus, the members of that non-majority cluster (e.g., a minority cluster) may be flagged.

As explained, one or more metrics may be utilized to facilitate clustering such that a majority group and a non-majority group may be identified. Further, as explained, a linear model may be utilized to generate values that can be utilized for clustering, which may help to effectively reduce the impact of noise. As an example, a framework may operate on data in an efficient manner to identify one or more issues, which may correspond to one or more underlying issues (e.g., a sensor issue, an acquisition issue, etc.).

As shown in the example of FIG. 6, a segmented linear approximation can be suitable applied to different series of data to facilitate the computation of a metric or metrics (e.g., a ratio and/or a difference). As explained, clustering may be applied to a metric or metrics where, for example, a suitable number of clusters may be specified, if a selected clustering technique depends on such a parameter (e.g., a hyperparameter). As explained, a silhouette score may be computed for a clustering result. As mentioned, silhouette score near +1 May be ideal. As an example, a method may implement a silhouette score cutoff. For example, if a silhouette score is less than 0.5, which may indicate there is not a sufficiently clear distinction between clusters (e.g., a sample is on or very close to a decision boundary between two neighboring clusters). In such an example, a window size may be adjusted and/or a metric may be adjusted. For example, an inappropriate window size and/or placement may result in data on a boundary or transition between majority and non-majority being analyzed, which may lack a sufficient number of majority members. In various instances, depending on window size, etc., a majority group may be in error. As an example, a method can include adjusting a window size as a parameter to determine what group may be in error and hence detrimental to R&R.

As an example, a database can provide for storing results for one or more tools, one or more sensors, one or more operators, one or more types of wells, one or more reservoir conditions, etc. As an example, a database for a sensor may indicate that a sensor may benefit from replacement and/or servicing. For example, consider a sensor that may acquire data that are flagged over a series of field operations. In such an example, data such as temperature, pressure, speed of conveyance, etc., may be taken into account to determine a mode of failure of the sensor and, for example, a suitable course of action for rectifying the issue with the sensor. In some instances, sensors may be specified to be operable over a temperature range and/or a pressure range, however, variability may exist for such sensors when they approach a limit or limits. For example, consider a sensor that may exhibit issues when both temperature and pressure limits are approached; whereas, a companion sensor from the same manufacturer may be operable without exhibiting such issues. In such an example, a history of the sensors may be examined and compared. For example, one of the sensors may be experiencing a decline in performance from extended periods of operating at or near limits (e.g., consider one sensor being newer than the other, etc.).

As an example, a linearization approach may provide one or more parameters that are indicative of signal-to-noise ratio. In such an example, one or more statistics from a linear approximation may be examined to determine if noise may be high or low. For example, consider an approach that can assess noise via one or more statistics for a non-majority group (e.g., cluster) to determine if noise may be coherent or non-coherent (e.g., non-random or random), which may have an impact on sensor performance and/or an underlying cause for suboptimal performance.

As an example, a framework may be implemented locally and/or remotely. For example, consider a downhole tool that can include a processor, memory and a power source that can perform an assessment downhole, which may be, for example, an assessment of multiple sensors and/or an assessment from multiple passes along a common span of a borehole. In such an example, data that are flagged may be stored and/or deleted. As an example, flagged data may be flagged as to non-transmission, whether by wired circuitry, wireless circuitry, mud-pulse telemetry, etc. Such an approach can conserve bandwidth and expedite transmission of non-flagged data. Where flagged data are stored in a downhole tool, they may be interrogated at surface once the downhole tool is pulled of a borehole.

As an example, where a multi-sensor tool or a string with multiple instances of a certain tool indicate that one sensor is not operating appropriately via an assessment, the string may automatically shut down the problematic sensor, which may act to conserve power and/or memory. If a tool relies on multiple sensors to make a measurement, an option may exist to shut down the tool where one of the multiple sensors is not operating properly per an assessment of data from the multiple sensors.

As an example, a framework may be implemented locally using an edge device. For example, consider a gateway as an edge device that may include one or more features of an AGORA gateway (e.g., v.202, v.402, etc.) and/or another gateway. For example, consider features such as an INTEL ATOM E3930 or E3950 dual core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS or another operating system). As an example, a gateway may include a cellular interface (e.g., 4G LTE with global modem/GPS, 5G, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm). As an example, a framework or a portion thereof may be operable using a gateway. In such an example, one or more frameworks and/or portions thereof may assess data from one or more sensors, which may include surface and/or downhole sensors. Where data are flagged, a flag or flags may be utilized to control transmission of information to a remote site, control local equipment, etc.

In various examples, two sets of data are compared. As an example, more than two sets of data may be compared. For example, consider a tool with three sensors where data acquired by the three sensors may be compared, optionally using an appropriate clustering technique, which may include a clustering parameter that specifies a number of cluster and/or a process for determining a number of clusters.

As an example, an assessment may provide for data adjustment. For example, if an issue arises that may be a periodic baseline issue, such an issue may be identified and data adjusted, though such data may be flagged as being adjusted data (e.g., for review, etc.). For example, consider a cluster that represents a shifted baseline compared to another cluster. In such an example, the shift may represent a baseline shift that can be utilized to adjust data.

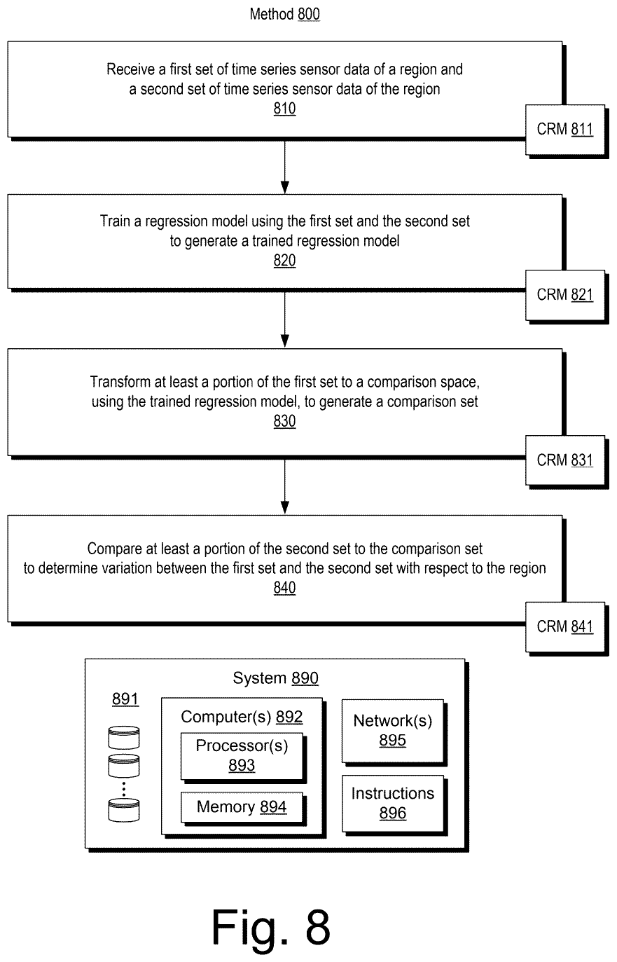

FIG. 8 shows an example of a method 800 and an example of a system 890. As shown, the method 800 can include a reception block 810 for receiving a first set of time series sensor data of a region and a second set of time series sensor data of the region; a training block 820 for training a regression model using the first set and the second set to generate a trained regression model; a transformation block 830 for transforming at least a portion of the first set to a comparison space, using the trained regression model, to generate a comparison set; and a comparison block 840 for comparing at least a portion of the second set to the comparison set to determine variation between the first set and the second set with respect to the region.

In the example of FIG. 8, the method 800 can include generating a first linear approximation set using the first set, generating a second linear approximation set using the second set, determining a metric using the first linear approximation set and the second linear approximation set, and clustering the metric to identify a first cluster associated with the first set and a second cluster associated with the second set. In such an example, training can include using time series data members of the first set from the first cluster and time series data members of the second set from the second cluster. As an example, a method can include performing a silhouette analysis on clustering to assess distance between a first cluster and a second cluster.

As an example, in the method 800 of FIG. 8, variation can indicate one or more of repeatability for one or more sensors, reproducibility for one or more sensors and/or inconsistency for one or more sensors.

The method 800 is shown in FIG. 8 in association with various computer-readable media (CRM) blocks 811, 821, 831, and 841. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 800. As an example, a computer-readable medium (CRM) may be a computer-readable storage medium that is non-transitory and that is not a carrier wave. As an example, one or more of the blocks 811, 821, 831 and 841 may be in the form processor-executable instructions.

In the example of FIG. 8, the system 890 includes one or more information storage devices 891, one or more computers 892, one or more networks 895 and instructions 896. As to the one or more computers 892, each computer may include one or more processors (e.g., or processing cores) 893 and memory 894 for storing the instructions 896, for example, executable by at least one of the one or more processors 893 (see, e.g., the blocks 811, 821, 831 and 841). As an example, a computer may include one or more network interfaces (e.g., wired or wireless), one or more graphics cards, a display interface (e.g., wired or wireless), etc.

As to types of machine learning models (ML models), while various examples have been described, one or more ML models may include features of one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California). As an example, a DATAIKU framework may be utilized (Dataiku, New York, New York).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and IoT devices.

TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, image classification, object detection, pose estimation, question answering, text classification, etc., on multiple platforms.

As an example, a method can include receiving a first set of time series sensor data of a region and a second set of time series sensor data of the region; training a regression model using the first set and the second set to generate a trained regression model; transforming at least a portion of the first set to a comparison space, using the trained regression model, to generate a comparison set; and comparing at least a portion of the second set to the comparison set to determine variation between the first set and the second set with respect to the region. In such an example, training can include generating a first linear approximation set using the first set, generating a second linear approximation set using the second set, determining a metric using the first linear approximation set and the second linear approximation set, and clustering the metric to identify a first cluster associated with the first set and a second cluster associated with the second set. As an example, training can include using time series data members of the first set from the first cluster and time series data members of the second set from the second cluster. As an example, a method can include performing a silhouette analysis on clustering to assess distance between a first cluster and a second cluster. As an example, clustering can include k-means clustering, for example, where a k parameter of the k-means clustering can be a selected value, a determined value (e.g., using an elbow approach), etc. As an example, k may be set to be equal to two or three or may be set to another appropriate value.

As an example, variation can indicate repeatability for one or more sensors, can indicate reproducibility for one or more sensors and/or can indicate an inconsistency for one or more sensors.

As an example, a region can include a borehole region of a borehole in a subsurface geologic environment.

As an example, a first set and a second set can be acquired by the same sensor (e.g., a common sensor). In such an example, the first set can be acquired over a first time period and the second set can be acquired over a second time period.

As an example, a first set and a second set can be acquired by different sensors. In such an example, the different sensors can be part of a common tool.

As an example, a method can include storing an indicator of variation in a database in association with a sensor. In such an example, a method can include, based on the indicator, issuing a service call for the sensor. For example, consider tracking values of indicators to determine whether a sensor is operating properly and/or may have a shortened life expectancy or shortened time to servicing.

As an example, a first set and a second set can include time series cement bond logging data. As an example, a first set and a second set can include time series acoustic data.

As an example, a system can include one or more processors; memory accessible to at least one of the one or more processors; processor-executable instructions stored in the memory and executable to instruct the system to: receive a first set of time series sensor data of a region and a second set of time series sensor data of the region; train a regression model using the first set and the second set to generate a trained regression model; transform at least a portion of the first set to a comparison space, using the trained regression model, to generate a comparison set; and compare at least a portion of the second set to the comparison set to determine variation between the first set and the second set with respect to the region.

As an example, one or more computer-readable storage media can include processor-executable instructions to instruct a computing system to: receive a first set of time series sensor data of a region and a second set of time series sensor data of the region; train a regression model using the first set and the second set to generate a trained regression model; transform at least a portion of the first set to a comparison space, using the trained regression model, to generate a comparison set; and compare at least a portion of the second set to the comparison set to determine variation between the first set and the second set with respect to the region.

As an example, a computer program product can include one or more computer-readable storage media that can include processor-executable instructions to instruct a computing system to perform one or more methods and/or one or more portions of a method.

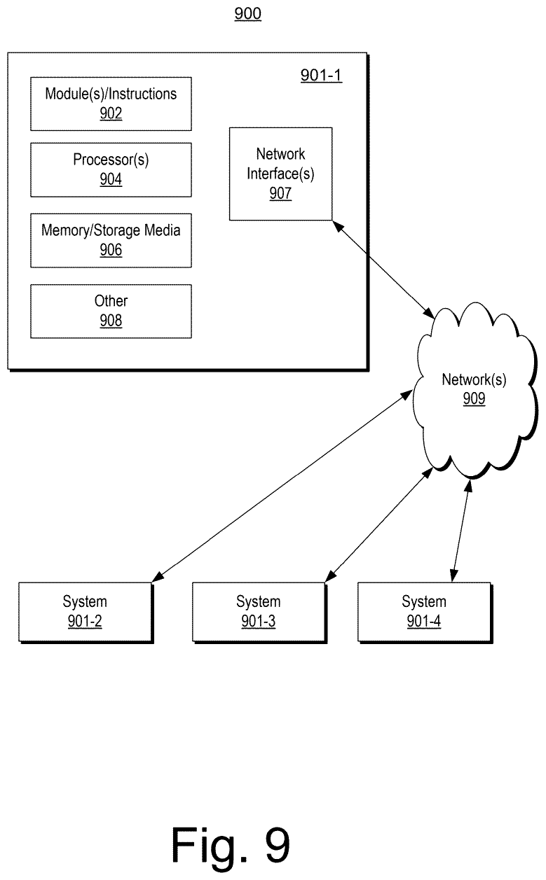

In some embodiments, a method or methods may be executed by a computing system. FIG. 9 shows an example of a system 900 that can include one or more computing systems 901-1, 901-2, 901-3 and 901-4, which may be operatively coupled via one or more networks 909, which may include wired and/or wireless networks.

As an example, a system can include an individual computer system or an arrangement of distributed computer systems. In the example of FIG. 9, the computer system 901-1 can include one or more modules 902, which may be or include processor-executable instructions, for example, executable to perform various tasks (e.g., receiving information, requesting information, processing information, simulation, outputting information, etc.).

As an example, a module may be executed independently, or in coordination with, one or more processors 904, which is (or are) operatively coupled to one or more storage media 906 (e.g., via wire, wirelessly, etc.). As an example, one or more of the one or more processors 904 can be operatively coupled to at least one of one or more network interfaces 907; noting that one or more other components 908 may also be included. In such an example, the computer system 901-1 can transmit and/or receive information, for example, via the one or more networks 909 (e.g., consider one or more of the Internet, a private network, a cellular network, a satellite network, etc.).

As an example, the computer system 901-1 May receive from and/or transmit information to one or more other devices, which may be or include, for example, one or more of the computer systems 901-2, etc. A device may be located in a physical location that differs from that of the computer system 901-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 906 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving a first set of time series sensor data of a region and a second set of time series sensor data of the region;
training a regression model using the first set and the second set to generate a trained regression model;
transforming at least a portion of the first set to a comparison space, using the trained regression model, to generate a comparison set; and
comparing at least a portion of the second set to the comparison set to determine variation between the first set and the second set with respect to the region.

2. The method of claim 1, wherein the training comprises generating a first linear approximation set using the first set, generating a second linear approximation set using the second set, determining a metric using the first linear approximation set and the second linear approximation set, and clustering the metric to identify a first cluster associated with the first set and a second cluster associated with the second set.

3. The method of claim 2, wherein the training comprises using time series data members of the first set from the first cluster and time series data members of the second set from the second cluster.

4. The method of claim 2, comprising performing a silhouette analysis on the clustering to assess distance between the first cluster and the second cluster.

5. The method of claim 2, wherein the clustering comprises k-means clustering.

6. The method of claim 5, wherein a k parameter of the k-means clustering is equal to two or three.

7. The method of claim 1, wherein the variation indicates repeatability for one or more sensors.

8. The method of claim 1, wherein the variation indicates reproducibility for one or more sensors.

9. The method of claim 1, wherein the variation indicates an inconsistency for one or more sensors.

10. The method of claim 1, wherein the region comprises a borehole region of a borehole in a subsurface geologic environment.

11. The method of claim 1, wherein the first set and the second set are acquired by the same sensor.

12. The method of claim 11, wherein the first set is acquired over a first time period and wherein the second set is acquired over a second time period.

13. The method of claim 1, wherein the first set and the second set are acquired by different sensors.

14. The method of claim 13, wherein the different sensors are part of a common tool.

15. The method of claim 1, comprising storing an indicator of the variation in a database in association with a sensor.

16. The method of claim 15, comprising, based on the indicator, issuing a service call for the sensor.

17. The method of claim 1, wherein the first set and the second set comprise time series cement bond logging data.

18. The method of claim 1, wherein the first set and the second set comprise time series acoustic data.

19. A system comprising:
one or more processors;
memory accessible to at least one of the one or more processors;
processor-executable instructions stored in the memory and executable to instruct the system to:
receive a first set of time series sensor data of a region and a second set of time series sensor data of the region;
train a regression model using the first set and the second set to generate a trained regression model;
transform at least a portion of the first set to a comparison space, using the trained regression model, to generate a comparison set; and
compare at least a portion of the second set to the comparison set to determine variation between the first set and the second set with respect to the region.

20. One or more computer-readable storage media comprising processor-executable instructions to instruct a computing system to:
receive a first set of time series sensor data of a region and a second set of time series sensor data of the region;
train a regression model using the first set and the second set to generate a trained regression model;
transform at least a portion of the first set to a comparison space, using the trained regression model, to generate a comparison set; and
compare at least a portion of the second set to the comparison set to determine variation between the first set and the second set with respect to the region.
